(19) United States
(12) Patent Application Publication
(10) Pub. No.: US 2012/0236404 A1
(43) Pub. Date: Sep. 20, 2012

(54) GIFT CARD WITH 3D LENSES

(76) Inventor: Sagi Kormandel, Corona Del Mar, CA (US)

(21) Appl. No.: 13/422,493

(22) Filed: Mar. 16, 2012

Related U.S. Application Data
(60) Provisional application No. 61/453,961, filed on Mar. 18, 2011.

(51) Int. Cl. G02B 27/22

(52) U.S. Cl. 359/463

(57) ABSTRACT

A card with integrated durable and easily portable 3D lenses for viewing 3D content. A device including 3D lenses incorporated into a gift card, a credit card, an identification card, a card that has an electric magnetic strip, a Smart Card or other type of similar card.

### RELATED APPLICATION

This application is a non-provisional of and claims priority to U.S. Provisional Patent Application No. 61/453,961, filed, Mar. 18, 2011, entitled GIFT CARD WITH 3D LENSES, to Kormandcl, which provisional application is incorporated herein by reference in its entirety.

### BACKGROUND

1. Field of the Invention

The present invention relates to three dimensional (3D) lenses.

2. Discussion of the Related Art

With the success of three dimensional (“3D”) material in the market rapidly growing, it is inevitable that most, if not all, brands will incorporate 3D into their campaigns and marketing material. One problem associated with 3D material is having 3D glasses readily available. Additionally, conventional 3D paper glasses wear out and or tear within a few times used and are not easily carried around.

Therefore, what is needed is a durable and easily portable 3D lenses for viewing 3D content.

### BRIEF DESCRIPTION OF THE DRAWINGS

The features and advantages of the present embodiments will be apparent from the following description, presented in conjunction with the following drawings, wherein:

FIG. 1 is a diagram illustrating a gift card with integrated 3D lenses in accordance with one embodiment.

Skilled artisans will appreciate that elements in the figures are illustrated for simplicity and clarity and have not necessarily been drawn to scale. For example, the dimensions, sizing, and/or relative placement of some of the elements in the FIGURE may be exaggerated relative to other elements to help to improve understanding of various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE DRAWINGS

The following description is not to be taken in a limiting sense, but is made merely for the purpose of describing the general principles of the invention. The scope of the invention should be determined with reference to claims (whether presented now or in the future). The present embodiments address the problems described in the background while also addressing other additional problems as will be seen from the following detailed description.

As mentioned above, with the success of three dimensional (“3D”) material in the market rapidly growing, it is inevitable that most, if not all, brands will incorporate 3D into their campaigns and marketing material. Rather than attaching conventional paper 3D glasses to marketing material, as an addition to marketing materials, the present embodiment incorporates 3D lenses into a gift card, a credit card, an identification card, a card that has an electric magnetic strip, a Smart Card or other type of similar card.

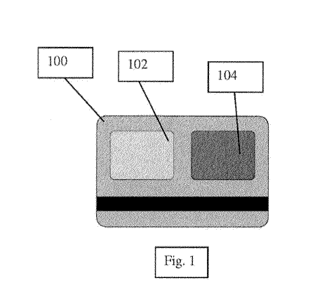

Referring to FIG. 1, shown is a gift card in accordance with one embodiment. Shown is the card 100, a first lens 102 and a second lens 104. The gift card 100 includes two holes in which the first lens 102 and the second lens 104 are placed. By holding the card up to their eyes the client can view a 3D image the same as if he had a pair of anaglyph or polarized conventional 3D glasses. The 3D gift card eliminates the need to carry around an extra pair of 3D glasses, which otherwise is an inconvenience. Additionally, conventional 3D paper glasses wear out and or tear within a few times used. The 3D gift card of the present embodiments is generally made from durable plastic, similar to a credit card or gift card. Finally, the 3D gift cards are easily stored in a purse or wallet.

The 3D glasses shown in FIG. 1 include one red (i.e. lens 104) and one cyan colored lens (i.e., lens 102). However, other color schemes may also he utilized in other embodiments and are within the scope of the currently contemplated embodiments. For example, red and blue lenses are utilized in one embodiment. Other embodiments include various possible combinations of colors for anaglyphs, including, for example, red-green, red-blue, greenblue, green-magenta (red+blue), or blue-yellow (red+green). Corresponding colors are used in the 3D drawings according to the color of the lenses of the glasses. Any colors that allow for creating and viewing 3D images can be utilized in various embodiments.

In one embodiment, a customer can swipe his card at the point of purchase in order to redeem credits that can then be used at the businesses website. For example, when using current gift cards, if a user has a gift card to a music store, the user will go to a music store to redeem a gift card (or potentially go online to use the redeem the gift card). However, there is no incentive for the user to add more money to the card for future purchases. That is, most people receive a gift card; spend the money on the card, and then throw it away. With the 3D Gift Card of the present invention, one embodiment includes a retail store's website that includes 3D content. In order to view the content, the user can use the 3D Gift Card that, for example, the user keeps in its wallet. Every time the user purchases a product, the card gets more “credits” that, for example, can be redeemed at the website for additional 3D content, games, photos, videos, etc. This provides an incentive for the consumer to keep the gift card even after they have spent the money on it. By not throwing the gill card away. the branding experience remains with the consumer at all times. This is extremely valuable for Brands and retailers. Additionally, in order to view 3D content, the user no longer needs to have 3D glasses on hand. Instead, the user can use the 3D credit card or 3D gift card that is in their wallet. This is possible because the embodiments described herein have two holes cut inside the card with a left lens and a right lens placed inside the holes.

In one embodiment, the card 100 is approximately 2⅛ inches×3⅜ inches. Other dimension, however, can be used in other embodiments.

While the invention herein disclosed has been described by means of specific embodiments and applications thereof, other modifications, variations, and arrangements of the present invention may be made in accordance with the above teachings other than as specifically described to practice the invention.

I claim:

1. A card comprising:
a body of the card;
a first lens, having a first color, integrated into the body of the card; and
a second lens, having a second color that is different from the first color, integrated into the body of the card adjacent to the first lens.

2. The card of claim 1 wherein the gift card can be used to view 3D content.

3. The card of claim 1 wherein the first color of the first lens is red and the second color for the second lens is cyan.

4. The card of claim 1 wherein the first color of the first lens and the second color of the second lens are selected from one of the following color combinations: red-cyan, red-green, red-blue, green-blue, green-magenta, and blue-yellow.

5. The card of claim 1, wherein the card is one of a gift card, a credit card, an identification card, a card that has an electric magnetic strip, and a Smart Card.

6. The card of claim 1, wherein the card is approximately 2⅛ inches by 3⅜ inches in dimensions.
